(19) United States
(12) Patent Application Publication
(10) Pub. No.: US 2015/0242386 A1
(43) Pub. Date: Aug. 27, 2015

(54) USING LANGUAGE MODELS TO CORRECT MORPHOLOGICAL ERRORS IN TEXT

(71) Applicant: Google Inc., Mountain View, CA (US)

(72) Inventors: Pedro J. Moreno Mengibar, Jersey City, NJ (US); Vladislav Schogol, Brooklyn, NY (US)

(73) Assignee: Google Inc., Mountain View, CA (US)

(21) Appl. No.: 14/190,597

(22) Filed: Feb. 26, 2014

(51) Int. Cl. G06F 17/27; G10L 19/00

(52) U.S. Cl. CPC G06F 17/273; G10L 19/00; G06F 17/2755

(57) ABSTRACT

Methods, systems, and apparatus, including computer programs encoded on a computer storage medium, for recognizing speech in an utterance. The methods, systems, and apparatus may include actions of obtaining a candidate transcription including a sequence of words and generating morphological variants of one or more of the words from the candidate transcription. Additional actions may include, for each morphological variant, generating one or more additional candidate transcriptions that each include the morphological variant. Further actions may include generating respective language model scores for the candidate transcription and the one or more additional candidate transcriptions. Additional actions may include selecting a particular transcription from among the candidate transcription and the one or more additional candidate transcriptions, based on the language model scores.

### TECHNICAL FIELD

This disclosure generally relates to speech recognition.

### BACKGROUND

A computer may be used to generate text. For example, a computer may use automatic speech recognition (ASR) to generate text from speech, statistical machine translation (SMT) to generate text in one language from text in another language, and optical character recognition (OCR) systems to generate text from images.

### SUMMARY

In general, an aspect of the subject matter described in this specification may involve a process for correcting text using a language model. Systems may often generate text that is not grammatically correct due to morphological errors. For example, an utterance of “PREVIOUSLY, THE COMPUTERS WERE HOT” may be incorrectly transcribed as “PREVIOUSLY, THE COMPUTER ARE HOT,” where the inclusion of “COMPUTERS” in the transcription instead of “COMPUTER” may be considered a morphological error in number, and the inclusion of “ARE” instead of “WERE” may be a morphological error in tense. Other types of morphological errors may also be found in other languages. For example, in Russian, morphological errors may occur when nouns are not properly inflected according to the context in which they occur, e.g. the preceding verb or preposition.

Morphological errors may occur because morphological variants of words may be similar in appearance, sound, or use. For example, the morphological variants “COMPUTER” and “COMPUTERS” may appear similar as they are distinguished in appearance by only an additional letter “S” at the end of “COMPUTERS.” “COMPUTER” and “COMPUTERS” may also sound similar as they are distinguished in sound by only an additional “S” sound.

A system may correct morphological errors in text using a language model. The language model may be trained using various textual sources to indicate how commonly sequences of one or more words appear in the various textual sources. The system may correct morphological errors by obtaining text and generating morphological variants of words in the text. For example, the system may receive the text “THE COMPUTER ARE HOT” and generate morphological variants of “COMPUTER,” e.g., “COMPUTERS,” generate morphological variants of “ARE,” e.g., “IS,” “AM,” “WAS,” “WERE,” and generate morphological variants of “HOT,” e.g., “HOTTER,” “HOTTEST,” and “HOTLY.”

The system may then generate a word lattice encoding the possible morphological variants for each of the words. For example, the system may generate a word lattice where each arc between a pair of nodes represents a morphological variant of a word. The word lattice may be composed with a language model to score all of the arcs in the word lattice according to how commonly the words represented by the arcs occur as indicated by the language model. For example, arcs associated with “COMPUTER ARE” may be scored less than arcs associated with “COMPUTERS ARE” because “COMPUTER ARE,” which may be inconsistent in number, may appear less frequently than “COMPUTERS ARE.” Similarly, arcs associated with “PREVIOUSLY” followed by “ARE” may be scored less than arcs associated with “PREVIOUSLY” followed by “WERE” because “PREVIOUSLY” followed by “ARE,” which may be inconsistent in tense, may appear less frequently than “PREVIOUSLY” followed by “WERE.”

The system may then determine a path that is indicated as most common, and select that path as the corrected text. For example, the system may determine that a path in the word lattice representing the text “PREVIOUSLY, THE COMPUTERS WERE HOT” has the highest language model score and select the text to use as corrected text for the received text “PREVIOUSLY, THE COMPUTER ARE HOT.”

In some aspects, the subject matter described in this specification may be embodied in methods that may include the actions of obtaining a candidate transcription including a sequence of words and generating morphological variants of one or more of the words from the candidate transcription. Additional actions may include, for each morphological variant, generating one or more additional candidate transcriptions that each include the morphological variant. Further actions may include generating respective language model scores for the candidate transcription and the one or more additional candidate transcriptions. More additional actions may include selecting a particular transcription from among the candidate transcription and the one or more additional candidate transcriptions, based on the language model scores.

Other versions include corresponding systems, apparatus, and computer programs, configured to perform the actions of the methods, encoded on computer storage devices.

These and other versions may each optionally include one or more of the following features. For instance, in some implementations generating morphological variants of one or more of the words from the candidate transcription may include determining a base form of a word of the one or more of the words and generating the morphological variants from the base form.

In some implementations, the morphological variants generated from the base form may include one or more of inflected forms of the base form or a non-inflected form of the base form.

In some aspects, for each morphological variant, generating one or more additional candidate transcriptions that each include the morphological variant, may include for each of the one or more words from the candidate transcription, identifying a set of morphological variants of the word, and generating the one or more additional candidate transcriptions to include one morphological variant from one or more of the identified sets of morphological variants.

In certain aspects, the respective language model scores for the candidate transcription and the one or more additional candidate transcriptions may reflect how commonly one or more words of the respective candidate transcription and the respective one or more additional candidate transcriptions appear in a language model.

In some implementations, selecting a particular transcription from among the candidate transcription and the one or more additional candidate transcriptions based on the scores may include determining a highest language model score from among the respective language model scores and selecting a transcription from among the candidate transcription and the one or more additional candidate transcriptions as the candidate transcription based on the highest language model score.

In some aspects, generating morphological variants of one or more of the words from the candidate transcription may include determining a weight for each of the morphological variants based on a distance of a word in an additional candidate transcription from a corresponding word in the obtained candidate transcription. Selecting a particular transcription from among the candidate transcription and the one or more additional candidate transcriptions may be further based on the determined weights.

In certain aspects, obtaining a candidate transcription may include a sequence of words may include receiving from an automated speech recognizer a transcription of an utterance as the candidate transcription.

In some implementations, the generated morphological variants of one or more of the words from the candidate transcription may be terms that are not received from the automated speech recognizer.

In some aspects, the actions may include receiving, from the automated speech recognizer, recognizer confidence scores for one or more words in the transcription received from the automated speech recognizer. Selecting a particular transcription from among the candidate transcription and the one or more additional candidate transcriptions may be further based on the recognizer confidence scores.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of an example system for correcting text using a language model.

FIG. 2 is an illustration of example lattices for correcting Russian text using a language model.

FIG. 3 is a flowchart of an example process for correcting text using a language model.

FIG. 4 is a diagram of exemplary computing devices.

Like reference symbols in the various drawings indicate like elements.

### DETAILED DESCRIPTION

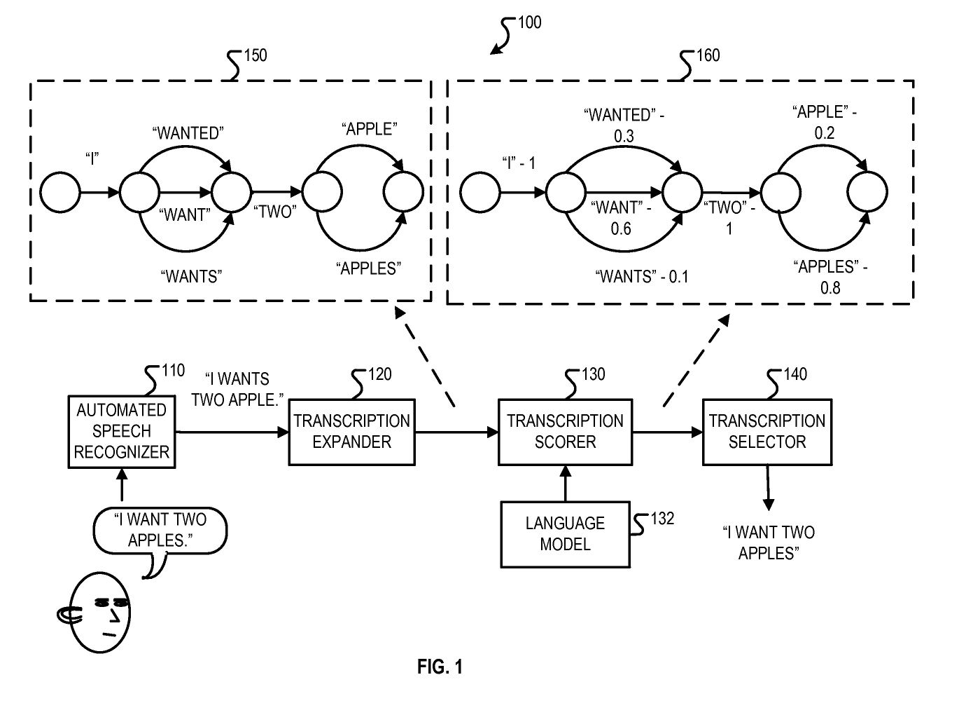

FIG. 1 is a block diagram of an example system 100 for correcting text using a language model. Generally, the system 100 may include an automated speech recognizer (ASR) 110 that may generate a candidate transcription of speech, a transcription expander 120 that may generate additional candidate transcriptions from the candidate transcription, a transcription scorer 130 that may generate language model scores for the candidate transcription and the additional candidate transcriptions using a language model 132, and a transcription selector 140 that may select a particular transcription from among the candidate transcription and the additional candidate transcriptions based on the language model scores.

The ASR 110 may perform automated speech recognition on an utterance from a user. For example, the ASR 110 may receive sounds corresponding to an utterance (in the figure, “I WANT TWO APPLES”) said by a user, where the sounds may be captured by an audio capture device, e.g., a microphone that converts sounds into an electrical signal. The ASR 110 may generate text that is a candidate transcription of the utterance. For example, the ASR 110 may generate the text “I WANTS TWO APPLE” as a candidate transcription. The candidate transcription “I WANTS TWO APPLE” is an incorrect transcription of the utterance “I WANT TWO APPLES” because the candidate transcription includes “WANTS,” which is an incorrect morphological variant of “WANT,” and “APPLE,” which is an incorrect morphological variant of “APPLES.”

The transcription expander 120 may generate additional candidate transcriptions from the candidate transcription. For example, from the candidate transcription, “I WANTS TWO APPLE,” the transcription expander 120 may generate the additional candidate transcriptions of “I WANTED TWO APPLE,” “I WANT TWO APPLE,” “I WANTED TWO APPLES,” “I WANT TWO APPLES,” and “I WANTS TWO APPLES.”

The transcription expander 120 may generate the additional candidate transcriptions by generating morphological variants for one or more words in the candidate transcriptions. For example, the transcription expander 120 may identify the word “WANT,” and generate a first set of morphological variants that includes “WANT,” “WANTED,” and “WANTS.” Similarly, the transcription expander 120 may identify the word “APPLE” and identify a second set of morphological variants that includes “APPLE” and “APPLES.” Each set of morphological variants may be morphological variants of a base word that is inflected differently. For example, “APPLE” and “APPLES” may be both forms of the word “APPLE,” except “APPLES” is inflected with an addition of “S” to be plural.

To generate the additional candidate transcriptions, the transcription expander 120 may identify one of the morphological variants for each word. For example, the transcription expander 120 may generate the additional candidate transcription, “I WANTED TWO APPLE,” by identifying “WANTED” from a set of morphological variants of “WANT” and identifying “APPLE” from a set of morphological variants of “APPLE.” The transcription generator 120 may generate another additional candidate transcription, “I WANT TWO APPLES,” by identifying “WANT” from the set of morphological variants of “WANT” and identifying “APPLES” from the set of morphological variants of “APPLE.”

The transcription expander 120 may generate morphological variants of a word using a morphological stemmer, analyzer, and generator (MSAG). The MSAG may determine a base word, e.g., a stem (of a word), analyze inflections that are applicable to the base word, and generate the morphological variants of the base word. For example, the MSAG may analyze the word “HOTTER,” determine that the base word of “HOTTER” is “HOT,” determine that “HOT” is an adjective and inflections for adjectives are applicable to “HOT,” and generate morphological variants “HOT,” “HOTTEST,” and “HOTLY,” for the word “HOTTER.”

The transcription expander 120 may encode all possible morphological variants for each of the words of a candidate transcription in the word lattice 150. The word lattice 150 may include nodes connected by arcs. Each arc may represent a potential morphological variant for a particular word, where a set of arcs between a particular pair of nodes may represent all the morphological variants for a particular word. For example, the word lattice 150 for the candidate transcription of “I WANTS TWO APPLE” may include five nodes, where a first and a second node are connected by an arc representing the word “I,” the second and a third node are connected by three arcs representing the corresponding morphological variants “WANTED,” “WANT,” and “WANTS,” the third and a fourth node are connected by an arc representing the word “TWO,” and the fourth and a fifth node are connected by two arcs representing the corresponding morphological variants “APPLE” and “APPLES.”

The transcription scorer 130 may obtain a candidate transcription and additional candidate transcriptions from the transcription expander 120 and generate language model scores for the candidate transcription and each of the additional candidate transcriptions. The language model scores may indicate how commonly sequences of one or more words of a candidate transcription and additional candidate transcriptions appear according to the language model 132.

For example, the transcription scorer 130 may generate language model scores of 0.06 for the additional candidate transcription “I WANTED TWO APPLE,” 0.24 for the additional candidate transcription “I WANTED TWO APPLES,” 0.12 for the additional candidate transcription “I WANT TWO APPLE,” 0.48 for the additional candidate transcription “I WANT TWO APPLES,” 0.02 for the candidate transcription, “I WANTS TWO APPLE,” and 0.08 for the additional candidate transcription, “I WANTS TWO APPLES.”

The transcription scorer 130 may generate the language models scores for the candidate transcription and each of the additional candidate transcriptions based on composing the language model 132 with the word lattice 150 to generate a composed word lattice 160 that includes the nodes and arcs of the word lattice 150, where each arc is associated with a corresponding arc score that indicates how likely the arc is to be correct based on how commonly the words that correspond to the arc appear according to the language model 132.

For example, the arc score for the arc representing “I” may be “1,” indicating that there is a 100% chance that “I” is correct. In the example, the arc score for the arc representing “WANTED” may be “0.3,” indicating a 30% chance that “WANTED” is correct, the arc score for the arc representing “WANT” may be “0.6,” indicating a 60% chance that “WANT” is correct, and the arc score for the arc representing “WANTS” may be “0.1,”, indicating a 10% chance that “WANTS” is correct. Further, the arc score for the arc representing “TWO” may be “1” and the arc score for the arc representing “APPLE” may be “0.2” and the arc score for the arc representing “APPLES” may be “0.8.”

To generate the language model score for a particular candidate transcription or particular additional candidate transcription, the transcription scorer 130 may multiply the arc scores corresponding to the words together. For example, the transcription scorer 130 may generate a language model score of 0.48 for the additional candidate transcription “I WANT TWO APPLES” based on multiplying together the arc score of “1” for “I,” the arc score of “0.6” for “WANT,” the arc score of “1” for “TWO,” and the arc score of “0.8” for “APPLES.”

The transcription scorer 130 may also remove or ignore arcs from the word lattice 150 based on the language model 132. For example, if the phrase “I WANTS” is indicated by the language model 132 as never appearing, the transcription scorer 130 may remove the arc representing the word “WANTS” from the composed word lattice 160.

The language model 132 may be trained using various textual sources to indicate how commonly one or more words appear in the various textual sources. For example, the language model 132 may be trained using text where “I WANTED” appears three times more often than “I WANTS,” and “I WANT” appears six times more often than “I WANTS.” In some implementations, the language model 132 used by the transcription scorer 130 may be different from a language model that may be used by the ASR 110 for speech recognition. For example, the language model 132 used by the transcription scorer 130 may represent how commonly a sequence of up to four words appears while the language model used by the ASR 110 for speech recognition may only represent how commonly a sequence of two or fewer words appear.

The transcription selector 140 may select a particular transcription from among the candidate transcription and the one or more additional candidate transcriptions, based on the language model scores. For example, from among a candidate transcription, “I WANTS TWO APPLE,” and additional candidate transcriptions, “I WANTED TWO APPLE,” “I WANTED TWO APPLES,” “I WANT TWO APPLE,” “I WANT TWO APPLES,” “I WANTS TWO APPLES,” the transcription selector 140 may select the additional candidate transcription, “I WANT TWO APPLES,” based on the language model scores.

The transcription selector 140 may select the candidate transcription or the additional candidate transcription that is associated with the highest language model score. For example, the transcription selector 140 may determine the highest language model score and select the candidate transcription or additional candidate transcription associated with the highest language model score. In a particular example, given the language model scores of 0.06 for the additional candidate transcription “I WANTED TWO APPLE,” 0.24 for the additional candidate transcription “I WANTED TWO APPLES,” 0.12 for the additional candidate transcription “I WANT TWO APPLE,” 0.48 for the additional candidate transcription “I WANT TWO APPLES,” 0.02 for the candidate transcription, “I WANTS TWO APPLE,” and 0.08 for the additional candidate transcription, “I WANTS TWO APPLES,” the transcription selector 140 may determine that the highest language model score is “0.48” and select the corresponding additional candidate transcription “I WANT TWO APPLES.”

The selected candidate transcription or additional candidate transcription may be considered the most likely to be correct. Where an additional candidate transcription may be selected instead of the original candidate transcription, the original candidate transcription may be replaced with the selected additional candidate transcription. For example, a speech to text application may display only a selected additional candidate transcription “I WANT TWO APPLES” instead of an original candidate transcription “I WANTS TWO APPLE.” Additionally or alternatively, the selected candidate transcription may be used in a suggestion for alternate text. For example, a speech to text application may display an original candidate transcription “I WANTS TWO APPLE” with an indication that this text may be incorrect and may be instead the selected additional transcription “I WANT TWO APPLES.”

In some implementations, the transcription selector 140 may also select a candidate transcription or an additional candidate transcription based on a recognition confidence score from the ASR 110. A recognition confidence score may indicate how confident the ASR 110 is that a word or a portion of a word is correctly recognized. For example, if the ASR indicates that “APPLE” in the candidate transcription is associated with a high recognition confidence score of “99%,” then the transcription selector 140 may more heavily weight the candidate transcription and any additional candidate transcriptions that include “APPLE” instead of other morphological variants of “APPLE.”

In some implementations, the transcription selector 140 may also select a candidate transcription or an additional candidate transcription based on an edit distance of morphological variants of words in the candidate transcription. An edit distance may indicate how different one word is from another. For example, the edit distance between “WANTS” and “WANT” may be a relatively small distance of “0.2” because the difference may only be the letter “5,” and the edit distance between “WANTS” and “WANTED” may be a relatively moderate distance of “0.4” because the difference may be omitting the suffix “5” and adding the suffix “ED.” The transcription selector 140 may weight against additional candidate transcriptions that include morphological variants with larger edit distances.

In some implementations, the system 100 may be used with text that is not generated by an ASR 110. For example, instead of an ASR 110, a statistical machine translator that generates text in one language from text in another language or an optical character recognizer that generates text from images may be used to obtain text that is provided to the transcription expander 120. The transcription expander 120, transcription scorer 130, and transcription selector 140 may operate under similar principles.

Different configurations of the system 100 may be used where functionality of the ASR 110, the transcription expander 120, the transcription scorer 130, the language model 132, and the transcription selector 140 may be combined, further separated, distributed, or interchanged. The system 100 may be implemented in a single device or distributed across multiple devices.

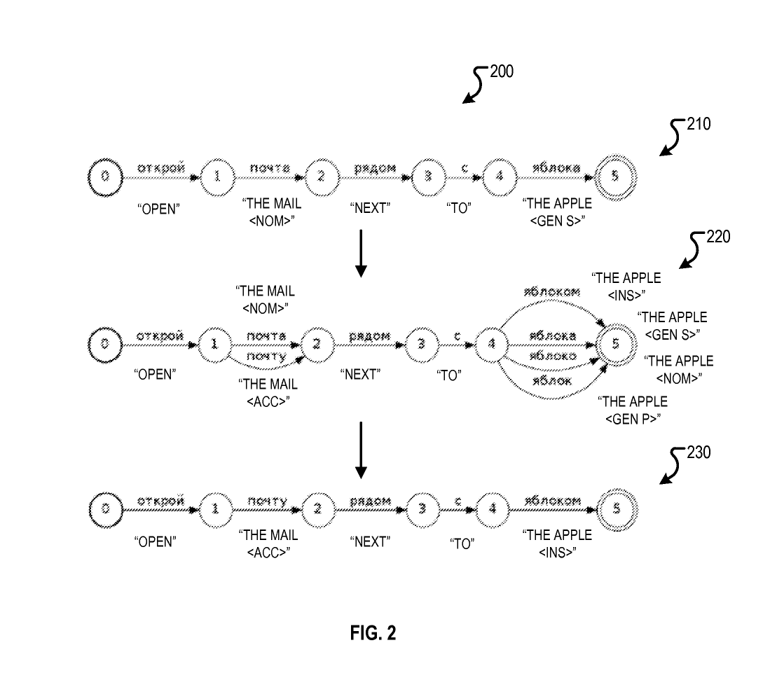

FIG. 2 is an illustration 200 of example word lattices for correcting Russian text using a language model. The first word lattice 210 encodes a candidate transcription “ [symbol] [symbol] [symbol] [symbol] [symbol] ,” which may correspond with the English translation “OPEN THE MAIL NEXT TO THE APPLE,” where “ [symbol] ” may be inflected to be nominative and “ [symbol] ” may be inflected to be genitive in singular form. This candidate transcription may be incorrect as the candidate transcription is grammatically incorrect. The candidate transcription would be correct if the accusative form of “ [symbol] ” and the instrumental form of “ [symbol] ” were used.

The second word lattice 220 encodes the candidate transcription “ [symbol] [symbol] [symbol] [symbol] [symbol] along with additional candidate transcriptions formed by morphological variants of the words in the candidate transcription. For example, the second word lattice 220 may include an additional arc representing “ [symbol] ” which is the accusative form morphological variant of the nominative form “ [symbol] .” The second word lattice 220 may also include additional arcs representing “ [symbol] ,” “ [symbol] ,” “ [symbol] ,” which represent instrumental, nominative, and genitive in plural form morphological variants of the nominative form “ [symbol] .”

The third word lattice 230 encodes a selected additional candidate transcription “ [symbol] [symbol] [symbol] [symbol] [symbol] .” The selected additional candidate transcription may represent a grammatically correct sentence where “ [symbol] ” is inflected to be accusative and “ [symbol] ” is inflected to be instrumental.

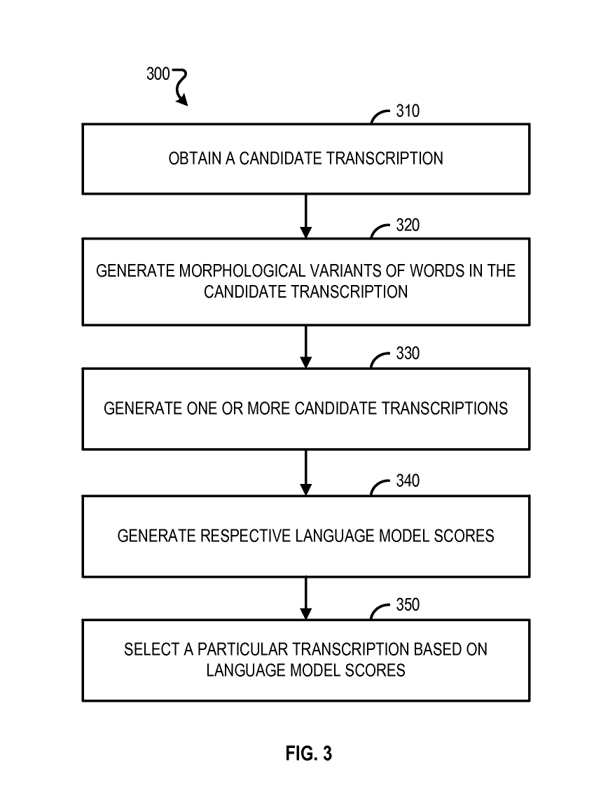

FIG. 3 is a flowchart of an example process 300 for correcting text using a language model. The following describes the process 300 as being performed by components of the system 100 that are described with reference to FIG. 1. However, the process 300 may be performed by other systems or system configurations.

The process 300 may include obtaining a candidate transcription (310). For example, the ASR 110 may incorrectly generate a Russian candidate transcription “ [symbol] [symbol] [symbol] [symbol] [symbol] ” (translation “OPEN THE MAIL <NOMINATIVE> NEXT TO THE APPLE <GENITIVE SINGULAR>”) that is grammatically incorrect from an utterance in Russian of “ [symbol] [symbol] [symbol] [symbol] [symbol] ” (translation “OPEN THE MAIL <ACCUSATIVE> NEXT TO THE APPLE <INSTRUMENTAL>”) that is grammatically correct.

The process 300 may include generating morphological variants of words in the candidate transcription (320). For example, the transcription expander 120 may identify all nouns in the candidate transcription and generate morphological variants for the nouns. The transcription expander 120 may generate “ [symbol] ” (translation “THE MAIL”<ACCUSATIVE>) and generate “ [symbol] ” (translation “APPLE” <INSTRUMENTAL>), “ [symbol] ” (translation “APPLE”<NOMINATIVE>), and “ [symbol] ,” (translation “APPLE”<GENETIVE PLURAL>).

The process 300 may include generating one or more candidate transcriptions (330). For example, the transcription expander 120 may generate a word lattice that encodes the candidate transcription “ [symbol] [symbol] [symbol] [symbol] [symbol] ” and the additional candidate transcriptions using nodes that are connected with arcs that represent the different generated morphological variants of words in the candidate transcription.

The process 300 may include generating respective language model scores (340). For example, the transcription scorer 130 may compose the word lattice with a Russian language model that has been trained with Russian text from various sources. The result of composing the word lattice with the Russian language model may be a composed word lattice with arcs that are associated with arc scores representing how commonly corresponding morphological variants of words represented by the arcs appear according to the Russian language model.

The process 300 may include selecting a particular transcription based on the language model scores (350). For example, the transcription selector 140 may determine from the composed word lattice the highest language model score and that the highest language model score is associated with the encoded additional candidate transcription “ [symbol] [symbol] [symbol] [symbol] [symbol] ,” and based on that determination, select the additional candidate transcription.

In some implementations, the system 100 may be used to correct other phenomena beyond inflections. For example, the system 100 may be used to correct orthographic errors, e.g., spelling errors, decomposition of tokens, e.g., “thisisaword” decomposed to “this is a word,” number expansion, e.g., “4334” replaced with “4000” and “334,” and transliterations, e.g., using different scripts of a language.

In some implementations, the system 100 may allow for the separation of the correction of inflection from the task of generating initial text. Using the system 100, the correction for morphological errors may be used in an offline process or by a server that is separate from a server that generates the initial text.

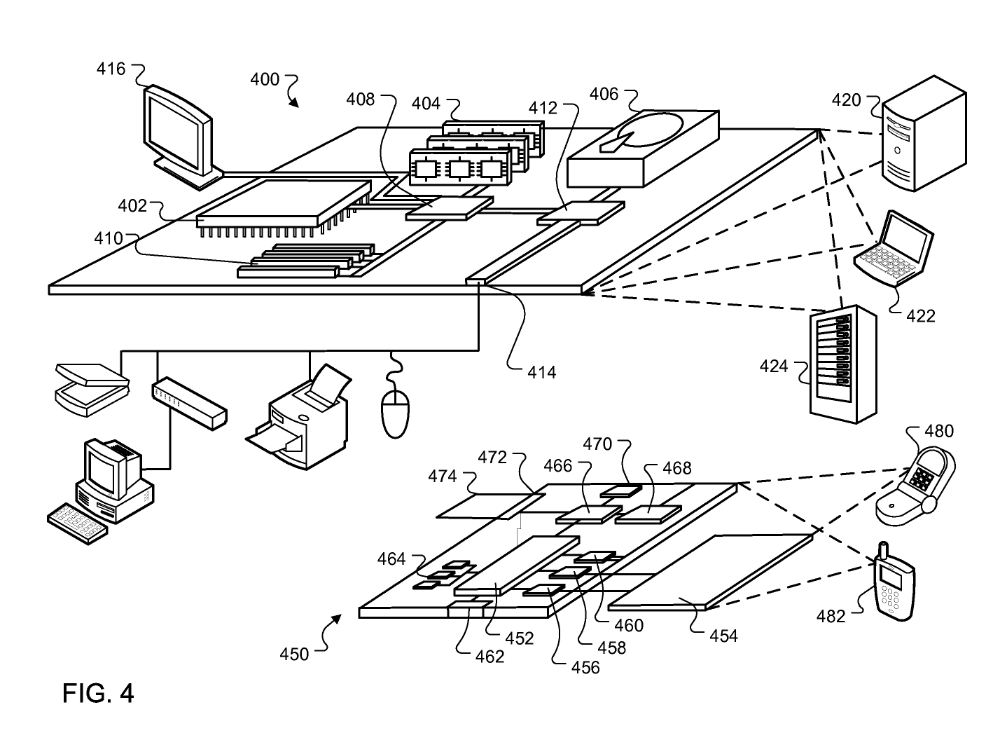

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or additionally, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

1. A method comprising:
obtaining a candidate transcription including a sequence of words;
generating morphological variants of one or more of the words from the candidate transcription;
for each morphological variant, generating one or more additional candidate transcriptions that each include the morphological variant;
generating respective language model scores for the candidate transcription and the one or more additional candidate transcriptions; and
selecting a particular transcription from among the candidate transcription and the one or more additional candidate transcriptions, based on the language model scores.

2. The method of claim 1, wherein generating morphological variants of one or more of the words from the candidate transcription comprises:
determining a base form of a word of the one or more of the words; and
generating the morphological variants from the base form.

3. The method of claim 2, wherein the morphological variants generated from the base form comprise one or more of: inflected forms of the base form or a non-inflected form of the base form.

4. The method of claim 1, wherein for each morphological variant, generating one or more additional candidate transcriptions that each include the morphological variant comprises:
for each of the one or more words from the candidate transcription, identifying a set of morphological variants of the word; and
generating the one or more additional candidate transcriptions to include one morphological variant from one or more of the identified sets of morphological variants.

5. The method of claim 1, wherein the respective language model scores for the candidate transcription and the one or more additional candidate transcriptions reflect how commonly one or more words of the respective candidate transcription and the respective one or more additional candidate transcriptions appear in a language model.

6. The method of claim 1, wherein selecting a particular transcription from among the candidate transcription and the one or more additional candidate transcriptions based on the scores comprises:
determining a highest language model score from among the respective language model scores; and
selecting a transcription from among the candidate transcription and the one or more additional candidate transcriptions as the candidate transcription based on the highest language model score.

7. The method of claim 1, wherein generating morphological variants of one or more of the words from the candidate transcription comprises:
determining a weight for each of the morphological variants based on a distance of a word in an additional candidate transcription from a corresponding word in the obtained candidate transcription,
wherein selecting a particular transcription from among the candidate transcription and the one or more additional candidate transcriptions is further based on the determined weights.

8. The method of claim 1, wherein obtaining a candidate transcription including a sequence of words comprises:
receiving from an automated speech recognizer a transcription of an utterance as the candidate transcription.

9. The method of claim 8, wherein the generated morphological variants of one or more of the words from the candidate transcription are terms that are not received from the automated speech recognizer.

10. The method of claim 1, further comprising:
receiving, from the automated speech recognizer, recognizer confidence scores for one or more words in the transcription received from the automated speech recognizer, wherein selecting a particular transcription from among the candidate transcription and the one or more additional candidate transcriptions is further based on the recognizer confidence scores.

11. A system comprising:
one or more computers; and
one or more storage devices storing instructions that are operable, when executed by the one or more computers, to cause the one or more computers to perform operations comprising:
obtaining a candidate transcription including a sequence of words;
generating morphological variants of one or more of the words from the candidate transcription;
for each morphological variant, generating one or more additional candidate transcriptions that each include the morphological variant;
generating respective language model scores for the candidate transcription and the one or more additional candidate transcriptions; and
selecting a particular transcription from among the candidate transcription and the one or more additional candidate transcriptions, based on the language model scores.

12. The system of claim 11, wherein generating morphological variants of one or more of the words from the candidate transcription comprises:
determining a base form of a word of the one or more of the words; and
generating the morphological variants from the base form.

13. The system of claim 12, wherein the morphological variants generated from the base form comprise one or more of: inflected forms of the base form or a non-inflected form of the base form.

14. The system of claim 11, wherein for each morphological variant, generating one or more additional candidate transcriptions that each include the morphological variant comprises:
for each of the one or more words from the candidate transcription, identifying a set of morphological variants of the word; and
generating the one or more additional candidate transcriptions to include one morphological variant from one or more of the identified sets of morphological variants.

15. The system of claim 11, wherein the respective language model scores for the candidate transcription and the one or more additional candidate transcriptions reflect how commonly one or more words of the respective candidate transcription and the respective one or more additional candidate transcriptions appear in a language model.

16. A computer-readable medium storing instructions executable by one or more computers which, upon such execution, cause the one or more computers to perform operations comprising:
obtaining a candidate transcription including a sequence of words;
generating morphological variants of one or more of the words from the candidate transcription;
for each morphological variant, generating one or more additional candidate transcriptions that each include the morphological variant;
generating respective language model scores for the candidate transcription and the one or more additional candidate transcriptions; and
selecting a particular transcription from among the candidate transcription and the one or more additional candidate transcriptions, based on the language model scores.

17. The medium of claim 16, wherein generating morphological variants of one or more of the words from the candidate transcription comprises:
determining a base form of a word of the one or more of the words; and
generating the morphological variants from the base form.

18. The medium of claim 17, wherein the morphological variants generated from the base form comprise one or more of: inflected forms of the base form or a non-inflected form of the base form.

19. The medium of claim 16, wherein for each morphological variant, generating one or more additional candidate transcriptions that each include the morphological variant comprises:
for each of the one or more words from the candidate transcription, identifying a set of morphological variants of the word; and
generating the one or more additional candidate transcriptions to include one morphological variant from one or more of the identified sets of morphological variants.

20. The medium of claim 16, wherein the respective language model scores for the candidate transcription and the one or more additional candidate transcriptions reflect how commonly one or more words of the respective candidate transcription and the respective one or more additional candidate transcriptions appear in a language model.
